(19) United States
(12) Patent Application Publication
(10) Pub. No.: US 2004/0010491 A1
(43) Pub. Date: Jan. 15, 2004

(54) User interface framework

(76) Inventor: Markus Riedinger, Fridinger (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/389,701

(22) Filed: Mar. 13, 2003

Related U.S. Application Data
(60) Provisional application No. 60/393,058, filed on Jun. 28, 2002.

(51) Int. Cl. G06F 17/30

(52) U.S. Cl. 707/3

(57) ABSTRACT

Systems and techniques are presented to find or locate resources in an organization using ontology. In general, in one implementation, the technique includes a system with a plurity of information sources and ontology defined to relate the information sources in a problem set, where the problem set may include metadata. A language can be used to define the ontology, where the language can include rules, statements, and declarative semantics. A query is initiated in a user interface, and an ontology search engine is configured to search the information sources from the parameters of the query.

### CROSS REFERENCE TO RELATED APPLICATIONS

This application claims the benefit of priority from U.S. Provisional Application entitled “Portal Framework Semantics”, filed Jun. 28, 2002, application Ser. No. 60/393,058, the disclosure of which is incorporated by reference.

### BACKGROUND

The following description relates to locating resources (e.g. people, or groups of people) using a user interface, for example, locating resources within an organization with a user interface (e.g. a portal interface) utilizing ontology-related metadata (i.e. data describing other data).

A common definition of ontology is a description, e.g. a formal specification of a program, of the concepts and relationships (e.g. documents have authors, documents belong to topics), as well as attributes (e.g. people with identifiers of first and last names) that can exist for a group or agents. Ontologies attempt to model cognitive problem sets for groups or agents called “problem sets”. Ontologies are written in a language that define the relations between concepts and specify logical rules for reasoning about the relations.

In particular, ontologies are described with a representation language to represent a conceptualization. Some examples of representation languages are Loom, Frame-Logic (abbr., F-logic), and KIF-based Ontololingua. These languages differ in their computational properties and expressiveness, however they can have a standard syntax.

In particular, F-logic is an example of a representation language that is a deductive, object-oriented database language that combines the declarative semantics and expressiveness of deductive database languages with the data modeling capabilities supported by an object-oriented data model. F-logic is a semantic language from the University of Freidurg.

Extensible Markup Language (XML) has emerged as a standard syntax for ontology-based languages. XML also has been used for other Resource Description Framework (RDF) schema. XML allows a user to add tags and structure to their documents and data. The XML tags can represent “metadata”—that is, information that characterizes the data in a document or file. Scripts or other programs can make use of these tags and assign meaning to them. For instance, if a document is assigned one or more XML tags, then a program can use the tags and a representation language to relate the document to the name of its creator and other documents with the same creator. A tag for the date of creation of the document also could be used to relate the document to other documents with the same creation date. A script or program also can define and relate XML tags in a taxonomic relationship where the metadata represent parent-child or sibling relationships.

Ontological systems can generally provide the functionality of inferences. Inference rules in ontologies enable programs, termed “inference engines”, to deduce new knowledge from knowledge that has been specified previously. A conventional version of a deductive database engine is Ontobroker by Ontoprise GmbH of Germany. Ontobroker processes F-logic statements.

Users of search engines typically interface with the search engines using a portal. The user inputs, for example, a natural-language query in the portal interface, and the search engine returns the results of the query to the portal interface.

### SUMMARY

The present application describes systems and techniques relating to locating or otherwise identifying resources within an organization or company with a user interface and an ontology engine. The ontology engine relates the metadata of files, folders, directories, projects, documents, tables, databases, and human resource information. The metadata is related, e.g. linked, to other metadata using ontologies and can include structured, semi-structured, or unstructured metadata. A user of a user interface (e.g. a portal interface) initiates a search or query to locate resources within an organization using a network of related metadata. For example, in one aspect a portal user initiates an “Expert Finder” query to search for resources including a person or a group of people with certain knowledge, skill, or experience attributes. The queried people may also be referred to as “knowledge workers”. In particular, the portal can be used as an interface to ontology-based search engine to locate a knowledge worker who has worked on a particular project, has worked with a particular customer, or has educational credentials in a particular field of study.

The portal interfaces with a user and the ontology-based search system. The ontology-based search system searches the metadata until an appropriate result can be returned to the portal. The ontology-based system also can serve as an inference engine that can infer new knowledge. Consequently, the portal also can be regarded as a type of “knowledge portal”. A knowledge portal attempts to grasp knowledge created by people as well as artificial intelligence to structure the knowledge based on a domain of interest, and to make the knowledge usable over the portal by people interested in the problem set.

If a knowledge worker needs to be located for a particular project, for example, then the search system can search the human resource database for employees who have worked on similar projects, the resumes of employees who have the skills or experience to work on that project, the billing records of that project, or the group leader of the targeted project. The employee can be located by the metadata of a document created by that employee. The ontology search system finds the information to locate the designated employee in one or more of these information sources. The information source also could be a specially-created information source, e.g. a knowledge base of metadata, that is created for the organization. Alternatively, the portal can be used to find resources across organizations or between companies.

The present application offers advantages over conventional relational systems. In a knowledge-intensive organization, terms, projects, and documents can change quickly and often. The ontologically-related metadata allows the relationships to remain fairly constant in a changing problem set of information sources. However, conventional relational systems tend either to be static, or they do not easily and quickly allow the user to find all of the information for a problem set with dynamic information sources. Among other advantages, techniques described here allow the system to “unhide” data that the user normally cannot get in conventional relational systems. Furthermore, it also allows the user to easily understand information through a portal, as well as inferring new knowledge.

In one aspect, a method of identifying resources in an organization includes creating a problem set from a plurity of information sources, and defining ontology for the problem set using the plurity of information sources. According to the ontology, arranging one or more information sources into a relational network that includes metadata associated with one or more information sources. Additionally, the problem set is searched with an ontology-based search engine, and the relational network is accessed with a portal.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 illustrates a block diagram of the structure of the ontology-based system.

FIG. 2 shows an example of information sources and a problem set.

FIG. 3 shows an example of locating resources within the information sources.

FIG. 4 shows related metadata.

FIG. 5 illustrates the sharing of information sources between organizations.

FIG. 6 shows a flowchart of identifying targeted information.

Like reference symbols in the various drawings indicate like elements.

### DETAILED DESCRIPTION

The systems and techniques described here relate to identifying or locating resources in an organization using ontology-based system with a user interface (e.g. a portal interface).

As used herein, the terms “electronic document” and “document” mean a set of electronic data, including both electronic data stored in a file and electronic data received over a network. An electronic document does not necessarily correspond to a file. A document may be stored in a portion of a file that holds other documents, in a single file dedicated to the document in question, or in a set of coordinated files.

Additionally, the term “organization” refers to a company or a business, government, or educational institution and the like. It also can refer to the personnel of an administrative and functional structure, such as a society or an association.

Furthermore, the term “ontology-based search engine” may refer to an ontology-based search engine, an ontology-based inference engine, an ontology-based search engine that interacts with an inference engine, or the combination of an ontology-based search engine and an inference engine.

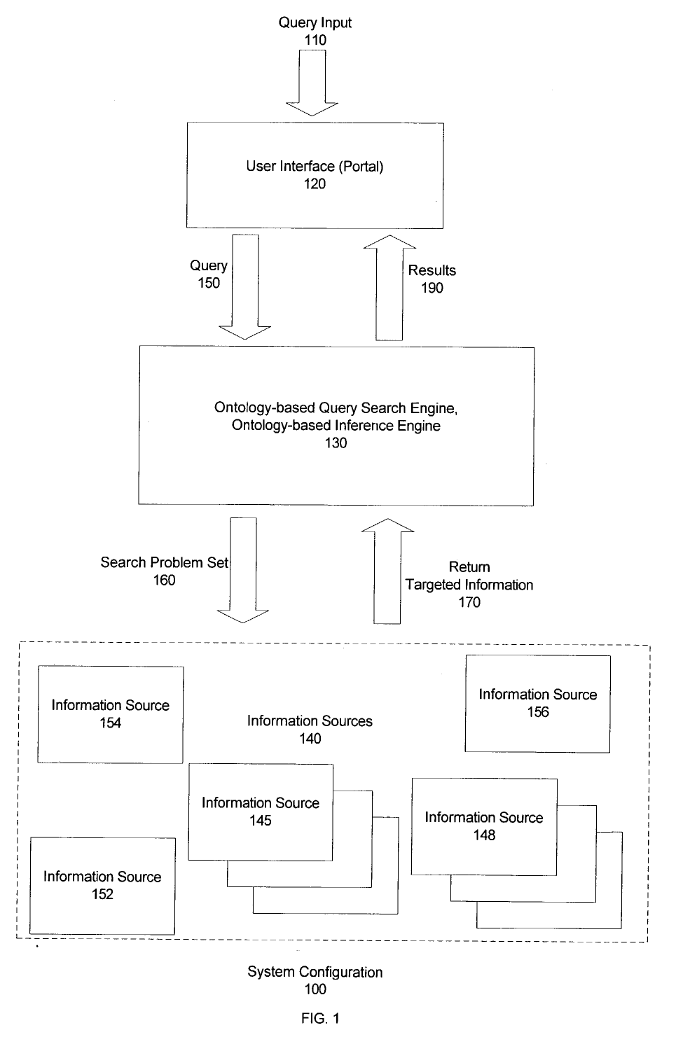

FIG. 1 is an exemplary illustration of a structure of an ontology based system configuration 100. A user inputs a query 110 in portal 120. The input 110 for the query can include input for a natural-language query. Alternatively, the query 110 can include a menu representation of the information sources, or a menu representation of problem sets for searching, or a navigation tree of either the information sources or the problem sets.

The query information 150 is sent to the ontology-based query search engine 130. The search engine includes metadata describing the information sources 140, and the engine can use ontology representation language, such as Loom or KIF-based Ontololingua, or a semantic representation language, such as F-logic, to build a knowledge base belonging to ontology of the query. The ontology can include concepts with relations, as well as attributes. In one aspect, the concepts of the ontology can be arranged in a taxonomic, tree-like structure, with parent-child relationships, or sibling relationships. In another aspect, the concepts of the ontology can be classified, ranked, or topically mapped. The ontology search engine can include rules with statements defined by the representation language.

Additionally, search engine 130 also can have the capabilities of an ontology-based inference engine. The search engine 130 can infer new knowledge or information from the existing knowledge or information.

A problem set is a subset of available information sources 140. The problem set is defined from the information sources 140 and a search 160 is conducted from the problem set. The targeted information 170 is then sent to the ontology-based search engine 130. The search engine 130 processes the targeted information and the processed results 190 are sent to the portal 120. The user can then use the portal to access the results of the query and determine whether the desired results were obtained.

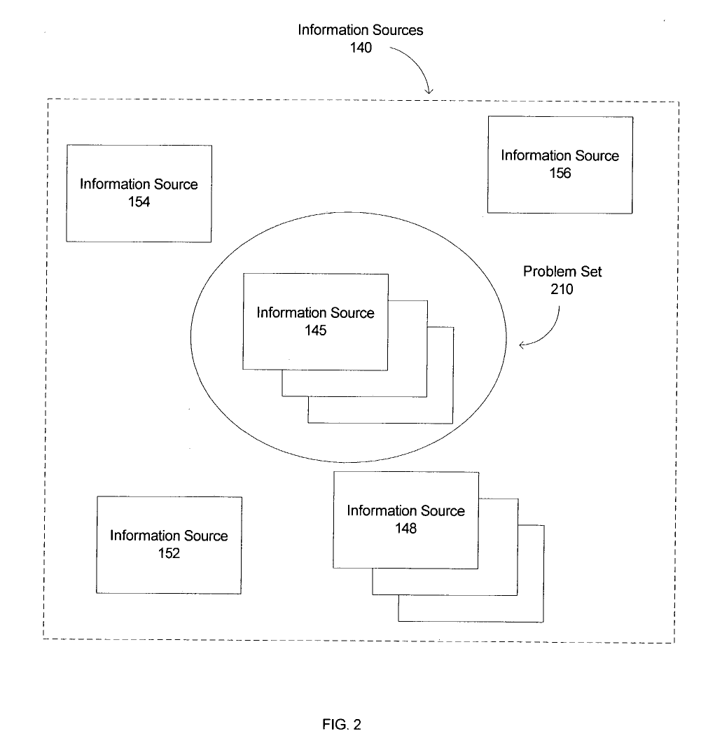

FIG. 2 shows an example of the problem set 210 within the available information sources 140. The problem set is determined from the parameters of the query information. The problem set can be defined by the resultant area of search 160 of the information sources 140 in the search engine from the query information, or the user can define the problem set 210 when submitting the query information in the portal. The problem set also can be determined by the relational network established by the ontology using the parameters of the query input. In FIG. 2, information source 145 is part of the problem set 210 for a given query input. The problem set does not relate the other information sources, such as 154, 148, or 152 for the given query. However, the problem set 210 could include those other information sources as part of the problem set for another query input.

An information source, such at 156, can be a dynamic information source that changes quickly and often. However, the ontology relates the metadata in the information sources 140 and can maintain the rules of the ontology even for dynamic information sources. The results of the ontology search can be independent of the sequence of the rules or the sequence of the statements within the rules. Hence, the ontology-based search or inference engine can be highly adaptable to changes in the information sources 140 or problem set 210.

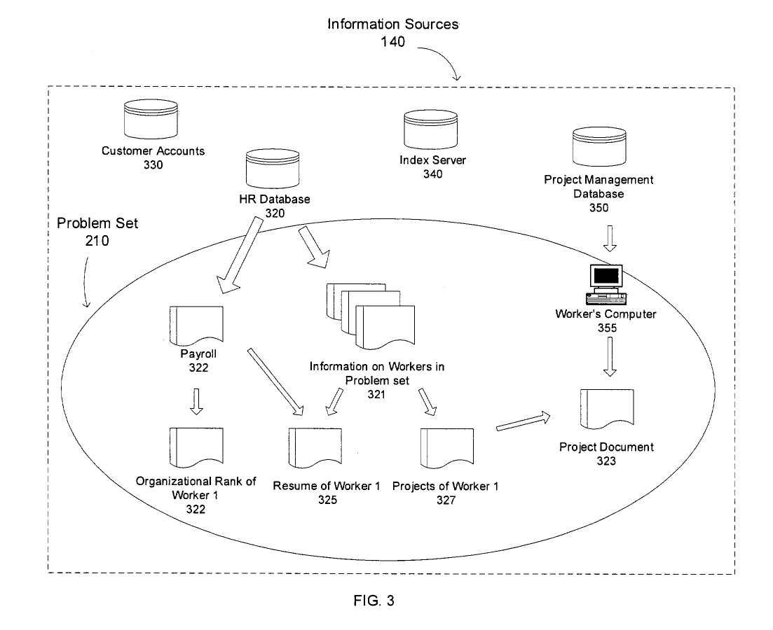

FIG. 3 shows another representation of the information sources 140. The information sources 140 can include customer accounts 330, index services, such as the index server 340, and repositories and databases, such as human resource database 320 and project management database 350. They also can include the information stored on individual networked computers, such as computer 355, including files and documents, such as project document 323. The information sources 140 also can include information stored on web pages, as well as documents on products, projects, presentations, and accounting data.

FIG. 3 is helpful in demonstrating how a user can find a knowledge worker or an employee in an organization. For example, if a portal user wanted to find a worker in an organization who has a certain skill area or experience working on a particular type of project, the portal user can input a query to cause the ontology engine to define a problem set 210 that includes the human resource database information. The ontology engine can search the metadata of payroll information 322 and find the organizational rank of the worker 322, or the resume of the worker 325. The ontology engine also can search the information of a group of workers in the problem set 321, and identify the targeted worker by the resume of the worker 325, or the projects the worker has completed 327. While documents such as project document 323 can be semi-structured or unstructured data, the index server 340 and database 320 can include structured data.

Moreover, the portal user can input a query to result in a search of the organization's project management database 350. The ontology engine can then search the database 350 and identify a related project document 323 from a worker's computer 355. The project document 323 can include information that is relevant to the parameters of the query search. Alternatively, the ontology engine functions as an inference engine and searches for a specific project document 323 from a file 327 with a list the completed projects of the worker. From the exemplary scenarios described above for FIG. 3., the portal user can use the resultant information to gain knowledge about the experience, rank, and skill areas of a worker.

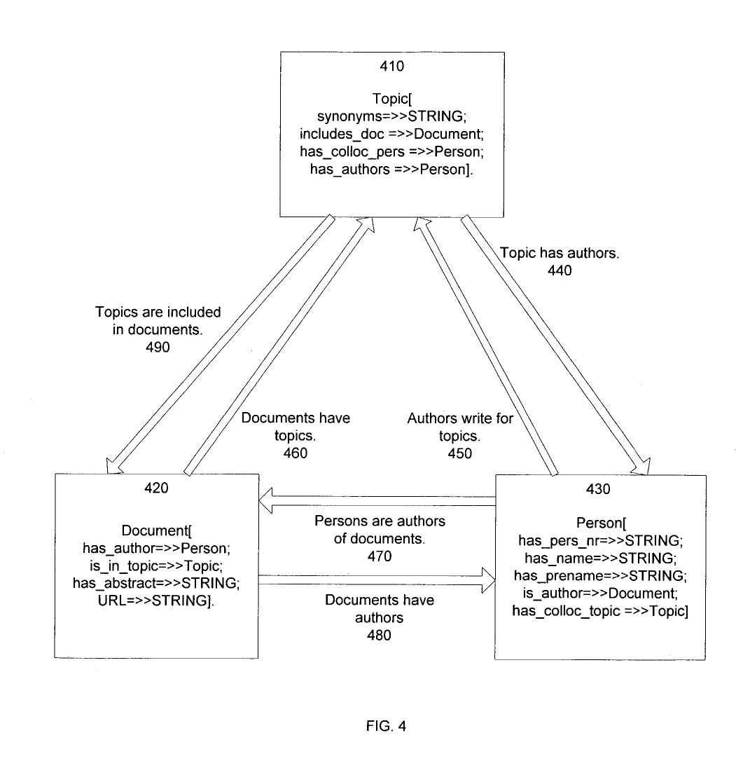

FIG. 4 illustrates examples of relations in an exemplary ontology in which experts are to be found for a topic 410. The topic 410 is included in documents 490 for a problem set 210. The documents 420 are written by authors 430. Authors are capable of externalizing knowledge on a specific topic in the form of information in documents. Consequently, they are considered experts on this topic.

Concepts have attributes that are significant in the possible identification of an expert. These attributes include the first and last names of persons in 430, and the Uniform Resource Locators (URLs) of the document 420.

As an illustrative example of ontology, FIG. 4 shows further relational details of ontology. The language used to define the ontology can include rules, statements, and declarative semantics. In topic 410, has_colloc_pers is defined by a rule used to attempt to find the name of a person in an unstructured document in proximity to a relevant term for a topic. When a portal user is looking for persons who have been involved in a document on a given topic, the persons who have been involved in a document on a subtopic are also of interest. Topics can be hierarchically arranged so that the subtopics address a portion of the subject area or problem set of the topic. However, due to the relational network of the ontology, the ontology engine can search for results in any direction in the hierarchy. The pairs of relations 490 and 460, 440 and 450, and 470 and 480 represent inverse relationships. For instance, the document 420 and topic 410 exhibit an inverse relationship with respect to is_in_topic and contains_doc. The results of the ontology engine search can therefore be independent of the sequence of the rules or the sequence of the statements within the rules.

FIG. 4 also illustrates an example of how the ontology-based search engine can be highly adaptable to changes in the problem set. For example, suppose a person 430 edits the contents of document 420, or moves the document to another storage location in the information sources 140. The topic 410 continues to be related to the document 420, and the document can still be easily located in the same manner. Additionally, the URL of the document can be dynamic and change often. Again, topic 410 remains related to document 420 and the document can be easily located.

The ontology allows the use of abstract models to build relational networks independently of data sources, and allow these relationships to remain fairly constant in a changing environment without loosing the information. The conventional relational network is fairly static and does not quickly and automatically adapt to changes in the data or the problem set. The conventional relational network also can be costly to service, update, and maintain for an organization with dynamic information sources.

Another example of ontology such as FIG. 4 can be modeled with ontology of projects, persons, and documents. For instance, a project has persons as members. The persons work on projects and produce documents. The documents include the published work of the members regarding the projects. The ontology engine can use the related metadata of projects, persons, or documents to find an expert for a given query.

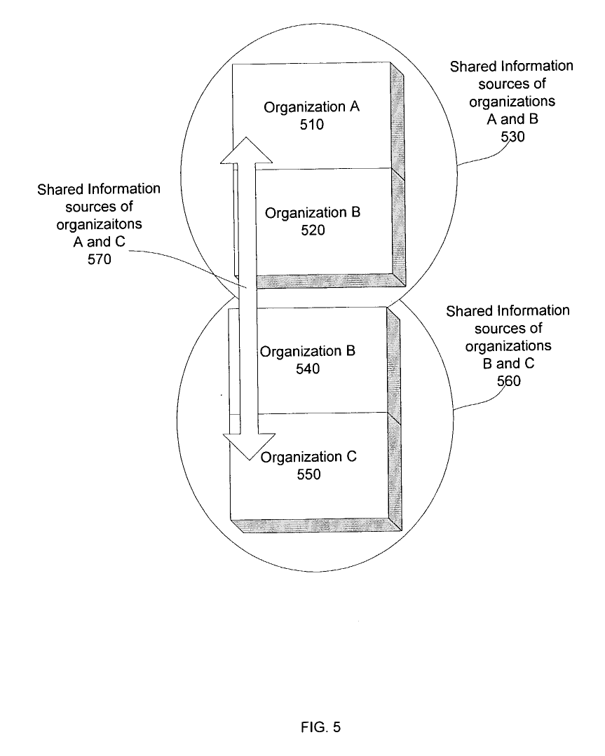

Among other advantages, techniques described here allow the system to “unhide” data that the user normally cannot get in conventional relational systems. For example, the ontology engine can find an expert or knowledge worker between several organizations. For instance, if two or more organizations share information sources, then the ontology can bridge the information sources of organizations that are not directly shared or connected. As shown in FIG. 5, if organization A 510 and organization B 520 share information sources 530, and organization B 540 and organization C 550 share information sources 560, then organizations A and C can share information sources 570 via the related information sources of organization B.

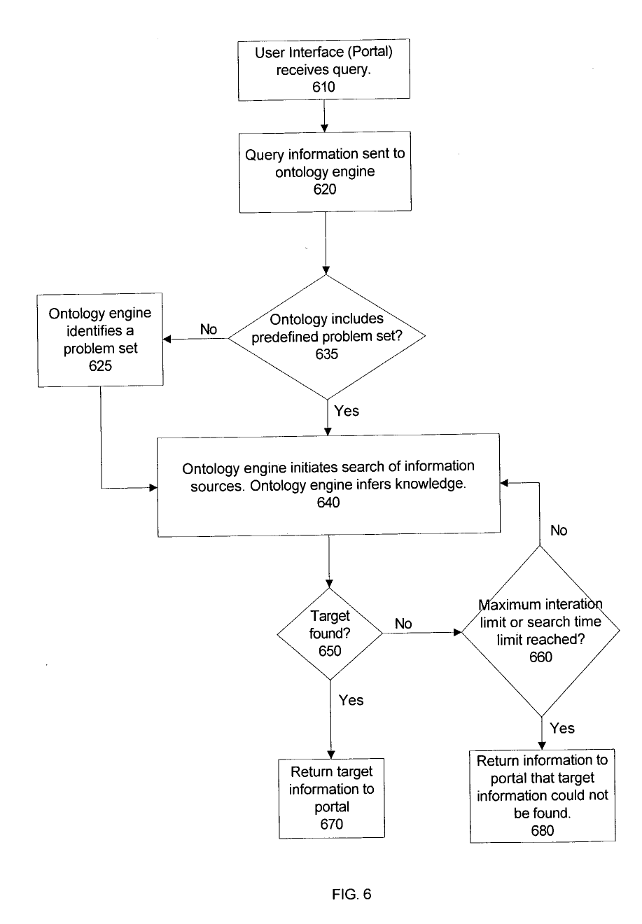

FIG. 6 illustrates a process of an ontology-based search. A user accesses a portal and inputs information for a query. The portal receives the query information 610 and sends the information to the ontology engine 620. The ontology engine then determines if a problem set was predefined by the user and included with the query information 635. If the ontology engine detects or identifies a predefined problem set, then the ontology engine searches the information sources of the problem set 640. If the ontology engine does not detect or identify a predefined problem set, then the ontology engine processes the query information and identifies a problem set 625. The ontology engine also can infer knowledge 640 from searching the metadata. The ontology engine can determine if the targeted information in the problem set has been found or identified 650. If the targeted information is found, then the targeted information is returned to the portal 670.

If the targeted information is not found, then the ontology engine continues to search the problem set and can even define or identify an alternative problem set for searching 640. If the target information is still not found after a maximum number of search iterations or within a maximum allotted time period 660, then the portal is sent information that the targeted information could not be found from the query input 680. The portal user also can be notified if a problem set cannot be defined or identified, or if the targeted information does not exist in the available information sources.

An example of a search that does not result in the ontology engine finding the targeted information can be demonstrated with reference to FIGS. 3 and 6. For example, if an expert or a knowledge worker with particular skill attributes is desired and is to be searched with the ontology engine, and if the problem set 210 with the human resource database 320 is the predefined problem set, then the portal can receive the results that the target information could not be found 680. This outcome might occur, for example, if the desired employee does not exist in the organization.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), an extranet or intranet, and the Internet.

The computing system can include clients and servers. A client and server are generally remote from each other and typically interact through a communication network. The relationship of client and server arises by virtue of computer programs running on the respective computers and having a client-server relationship to each other.

Although only a few embodiments have been described in detail above, other modifications are possible. Portions of this disclosure discuss using XML as standard syntax for ontology-based languages. However, the standard syntax also could include a variant of XML including SHOE, Ontology Exchange Language (XOL), Ontology Markup Language (OML and CKML), Resource Description Framework Schema Language (RDFS or RDF), and Riboweb. The logic flows depicted in FIGS. 1-6 do not require the particular order shown, or sequential order, to achieve desirable results. For example, the search path for a document in FIG. 3 may be performed at many different places within the overall process. In certain implementations, multitasking and parallel processing of two or more search engines may be preferable. In other applications, more than one problem set can be predefined by the user or determined by the ontology search engine. Additionally, the ontology engine can interface to more than one portal, or a portal can send and receive query information from several ontology engines where each engine searches disparate information sources. Furthermore, the knowledge worker query and search can include groups of people and individuals of other organizations.

Other embodiments may be within the scope of the following claims.

What is claimed is:

1. A method of identifying resources in an organization, the method comprising:
creating a problem set from a plurality of information sources;
defining an ontology for the problem set using the plurality of information sources;
according to the ontology, arranging one or more information sources into a relational network that includes metadata associated with the one or more information sources;
searching the problem set with a search engine; and
accessing the relational network with a user interface.

2. The method of claim 1, wherein the information sources include at least one dynamic information source.

3. The method of claim 1, further comprising:
locating resources in a plurity of organizations, in which each organization shares information sources with other organizations.

4. The method of claim 1, wherein the information sources include one or more of structured, semi-structured, and unstructured information.

5. A method of identifying one or more persons in an organization, the method comprising:
creating a problem set from a plurality of information sources;
defining an ontology for the problem set using the plurality of information sources;
according to the defined ontology, arranging one or more information sources into a relational network that includes metadata associated with the one or more information sources;
searching the problem set with a search engine; and
accessing the relational network with a user interface.

6. The method of claim 5, wherein the information sources include one or more dynamic information sources.

7. The method of claim 5, further comprising:
locating resources in a plurity of organizations, in which each organization shares information sources with other organizations.

8. The method of claim 5, wherein the problem set includes one or more of structured, semi-structured, and unstructured information.

9. The method of claim 5, wherein the ontology uses an extensible Markup Language (XML) data model.

10. The method of claim 5, wherein the search engine is an ontology-based search engine that is adaptable to changes in the problem set.

11. A method of identifying one or more persons in an organization, the method comprising:
initiating a query for a set of one or more persons;
sending query information to an ontology-based search engine; and
defining a problem set within a plurity of information sources, wherein the search engine includes ontology-based rules and searches for information within the problem set based on the query.

12. The method of claim 11, wherein the ontology-based search engine is a deductive database engine.

13. The method of claim 11, further comprising:
locating people or a set of people in a plurity of organizations, in which each organization shares information sources with other organizations.

14. The method of claim 11, wherein the problem set includes metadata.

15. The method of claim 11, wherein the information sources include one or more dynamic information sources.

16. The method of claim 11, wherein the information sources include databases storing information related to one or more of projects, products, human resource and employment information, and customer accounts.

17. The method of claim 11, wherein the information sources include documents corresponding to one or more of products, projects, sales, and presentations.

18. The method of claim 11, wherein the ontology-based search engine is adaptable to changes in the problem set.

19. The method of claim 11, further comprising defining the rules with language statements.

20. The method of claim 19, wherein the results are independent of a sequence of the rules or a sequence of the statements within the rules.

21. A system for identifying a set of one or more persons in an organization, the system comprising;
a plurity of information sources;
an ontology defined to relate the plurality of information sources in a relational network that includes metadata associated with the one or more information sources;
a user interface utilizing the ontology; and
an ontology engine configured to search the plurality of information sources from a query initiated in the user interface.

22. The system of claim 21, wherein the information sources include one or more dynamic information sources.

23. The method of claim 21, wherein the ontology engine is adaptable to changes in the problem set.

24. A system comprising:
a plurity of information sources;
an ontology defined to relate the plurality of information sources in a problem set that includes metadata;
a language to define the ontology, wherein the language includes rules, statements, and declarative semantics; and
an ontology search engine configured to search the plurality of information sources based on a received query.

25. The system of claim 24, wherein the information sources include one or more dynamic information sources.

26. The system of claim 24, wherein the results are independent of a sequence of the rules or a sequence of the statements within the rules.

27. The system of claim 24, wherein the system is used for identifying a person or a set of persons in an organization.

28. An article comprising a machine-readable medium storing instructions operable to cause one or more machines to perform operations comprising:
create a problem set from a plurality of information sources;
define an ontology for problem set using the plurality of information sources;
according to the ontology, arrange one or more information sources into a relational network that includes metadata associated with the one or more information sources;
search the problem set with an ontology-based search engine; and
access the relational network with a user interface.

29. The article of claim 28, wherein the ontology-based search engine is adaptable to changes in the problem set.

30. The article of claim 28, wherein the problem set includes one or more of structured, semi-structured, and unstructured information.

31. The article of claim 28, wherein one or more machines further perform the operation of identifying a person or a set of persons in an organization.

32. An article comprising a machine-readable medium storing instructions operable to cause one or more machines to perform operations comprising:
initiate a query for a set of one or more persons;
send query information to an ontology-based search engine;
define a problem set within a plurity of information sources, wherein the ontology-based search engine includes ontology-based rules and searches for information within the problem set based on the query;
retrieve results from the search engine; and
access the results.

33. The article of claim 32, wherein the ontology-based search engine is adaptable to changes in the problem set.

34. The article of claim 32, wherein one or more machines further perform the operation of identifying a person or a set of persons in an organization.

35. The article of claim 32, wherein the rules are defined with a language with statements.

36. The article of claim 35, wherein the results are independent of a sequence of the rules or a sequence of the statements within the rules.

37. The article of claim 35, further comprising instructions to locate resources in a plurity of organizations, in which each organization shares information sources with other organizations.

38. The article of claim 37, further comprising:
an information source of a first organization;
an information source of a second organization, wherein the first organization and the second organization share information sources;
an information source of a third organization, wherein the second organization and the third organization share information sources separately from the shared information sources of the first organization and the second organization; and
an ontology relating the information source of the first organization and the information source of the third organization, wherein information sources are shared between the first organization and the third organization using the ontology and the information source of the second organization.
